(19) United States
(12) Patent Application Publication
(10) Pub. No.: US 2025/0341896 A1
(43) Pub. Date: Nov. 6, 2025

(54) ADAPTIVE HAPTICS

(71) Applicant: Apple Inc., Cupertino, CA (US)

(72) Inventors: Nunyo K. Zigah, San Jose, CA (US); Jonathan A. Gordon, San Jose, CA (US); Hamza Kashif, San Jose, CA (US); Jules K. Fennis, Seattle, WA (US); Robert A. Nettles-Miller, San Jose, CA (US); Surya Lakshmivarahan, San Jose, CA (US)

(21) Appl. No.: 19/193,863

(22) Filed: Apr. 29, 2025

Related U.S. Application Data
(60) Provisional application No. 63/641,331, filed on May 1, 2024.

(51) Int. Cl. G06F 3/01; G06F 3/0354

(52) U.S. Cl. CPC G06F 3/016; G06F 3/03545

(57) ABSTRACT

A user input device includes a force sensor operable to determine an amount of force applied to at least one user input surface, and a haptic engine configured to provide a haptic output. The haptic output is provided at least partly in response to the amount of force satisfying a current configuration of a configurable user input force threshold and is based at least partly on a predetermined parameter associated with the current configuration of the configurable user input force threshold.

### CROSS-REFERENCE TO RELATED APPLICATIONS

This application claims the benefit under 35 U.S.C. § 119 (e) of U.S. Provisional Patent Application No. 63/641,331, filed May 1, 2024, the contents of which are incorporated herein by reference as if fully disclosed herein.

### FIELD

The described embodiments generally relate to force sensors and haptic engines, and to the provision of haptic outputs in response to force-based user inputs.

### BACKGROUND

Some electronic devices include a force sensor. The force sensor may have a user input surface to which a user may apply a force, or the force sensor may be disposed under a user input surface to which a user may apply a force. The force sensor may be associated with a user input force threshold, such that a force-based user input is not recognized by the force sensor until an amount of force applied to the user input surface satisfies (e.g., is greater than) the user input force threshold.

Some electronic devices include a haptic engine in addition to a force sensor. The haptic engine may provide haptic outputs (e.g., haptic feedback) to a user. In some cases, a haptic engine may provide a haptic output to acknowledge the receipt of a force-based user input (e.g., an amount of force applied to a user input surface, which amount of force satisfies a user input force threshold).

### SUMMARY

Embodiments of the systems, devices, methods, and apparatus described in the present disclosure are directed to force sensors having configurable user input force thresholds, and to haptic engines that are configured to provide different haptic outputs in response to force-based user inputs that satisfy different user input force thresholds.

In a first aspect, the present disclosure describes a user input device. The user input device may include a force sensor and a haptic engine. The force sensor may be operable to determine an amount of force applied to at least one user input surface by a user of the user input device. The haptic engine may be configured to provide a haptic output to the user. The haptic output may be provided at least partly in response to the amount of force satisfying a current configuration of a configurable user input force threshold and based at least partly on a predetermined parameter associated with the current configuration of the configurable user input force threshold.

In a second aspect, the present disclosure describes another user input device. The user input device may include a force sensor, a haptic engine, and control circuitry. The force sensor may be operable to determine an amount of force applied to at least one user input surface by a user of the user input device. The control circuitry may be configured to determine whether a set of one or more conditions is satisfied. The haptic engine may be configured to provide a haptic output to the user. The haptic output may be provided at least partly in response to the amount of force satisfying a first user input force threshold when the set of one or more conditions is not satisfied. The haptic output may be provided at least partly in response to the amount of force satisfying a second user input force threshold while the set of one or more conditions is satisfied or within a time period after the set of one or more conditions is satisfied. The second user input force threshold may be greater than the first user input force threshold.

In a third aspect, the present disclosure describes a method of operating a user input device. The method may include determining a selected user input force threshold; determining a parameter of a haptic output based at least in part on the selected user input force threshold; determining that an amount of force applied to at least one user input surface of the user input device satisfies the selected user input force threshold; and triggering, at least partly in response to the amount of force applied to the at least one user input surface satisfying the selected user input force threshold, the haptic output. The haptic output may be based at least in part on the parameter of the haptic output.

In addition to the aspects and embodiments described above, further aspects and embodiments will become apparent by reference to the drawings and by study of the following description.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A shows an example of an electronic device that includes, or functions as, a user input device;

FIG. 1B shows a system of electronic devices that includes a user input device;

FIG. 2 shows an example of a stylus that includes, or functions as, a user input device;

FIG. 3 shows an example of a user input device including a force sensor, a haptic engine, and optional control circuitry;

FIG. 4 shows an example graphical user interface that may be displayed on an electronic device, such as one of the electronic devices described with reference to FIG. 1A or 1B;

FIG. 5 shows an example mapping of different user input force thresholds to different parameters of a haptic output;

FIG. 6 illustrates an example adjustment of a user input force threshold, the adjustment occurring in response to a set of one or more conditions being satisfied;

FIG. 7A shows a first example method of operating a user input device;

FIG. 7B shows a second example method of operating a user input device; and

FIG. 8 shows an example electrical block diagram of an electronic device, such as one of the electronic devices described with reference to FIG. 1A or 1B.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Reference will now be made in detail to representative embodiments illustrated in the accompanying drawings. It should be understood that the following description is not intended to limit the embodiments to one preferred embodiment. To the contrary, it is intended to cover alternatives, modifications, and equivalents as can be included within the spirit and scope of the described embodiments and appended claims.

Some electronic devices enable a user to apply a force-based user input to one or more user input surfaces of the device. The force-based user input may be, for example, a press on a single user input surface, or a squeeze (e.g., a pinch) on a pair of user input surfaces. For an applied force to be recognized as an intended force-based user input, the force may need to satisfy a user input force threshold. Stated differently, applied forces that satisfy the user input force threshold may be recognized as force-based user inputs, and applied forces that do not satisfy the user input force threshold may be regarded as accidental or unintended applications of force.

A user input force threshold may be set such that most users find it easy to provide a force-based user input, but not so easy that they trigger unintended force-based user inputs. However, some users may find that they have to press or squeeze harder than is comfortable, and other users may find that they too frequently trigger an unintended force-based user input.

Described herein are force sensors that have configurable user input force thresholds. A user may therefore select a desired user input force threshold for a force sensor in their device, and the selected user input force threshold may override any default user input force threshold that was set for the force sensor.

Also described herein are haptic engines that are configured to provide different haptic outputs in response to force-based user inputs that satisfy different user input force thresholds. In some cases, different haptic outputs may be provided so that a same haptic perception is experienced by users who configure the force sensors of their devices to have different user input force thresholds. For example, User A, who has a Type X stylus, may configure the force sensor of their stylus to have a relatively low user input force threshold. When User A provides an amount of force that satisfies the relatively low user input force threshold, a haptic engine of their stylus may provide a relatively less intense haptic output to acknowledge receipt of their force-based user input. In contrast, User B, who also has a Type X stylus, may configure the force sensor of their stylus to have a relatively high user input force threshold (i.e., a user input force threshold that is higher than the user input force threshold set by User A). When User B provides an amount of force that satisfies the relatively high user input force threshold, a haptic engine of their stylus may provide a relatively more intense haptic output to acknowledge receipt of their force-based user input. The haptic engine of User B's stylus may provide a relatively more intense haptic output to account for the fact that the user input surface(s) of User B's stylus experience greater mechanical damping as a result of the greater amount of force that User B needs to apply to trigger a force-based user input. When the parameters of the haptic outputs provided by User A's stylus and User B's stylus are properly chosen, the haptic outputs perceived by User A and User B may be the same, regardless of the fact that they are applying different amounts of force to trigger their force-based user inputs.

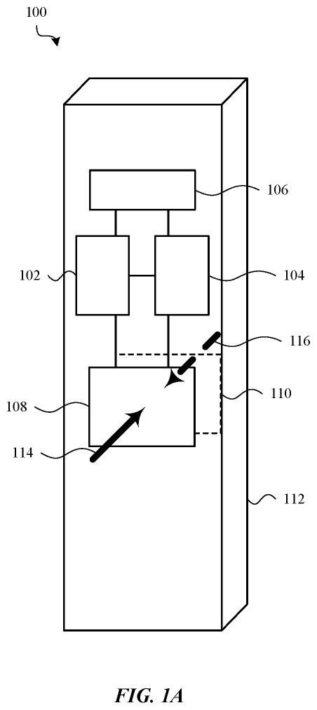

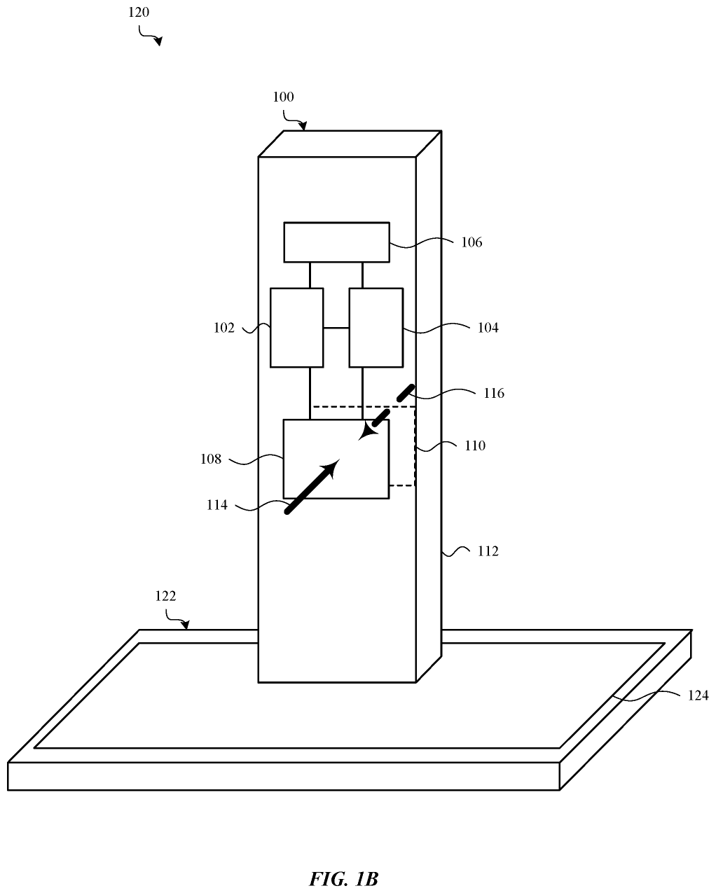

Turning now to FIG. 1A, FIG. 1A shows an example of an electronic device 100 that includes, or functions as, a user input device. By way of example, the electronic device 100 may be a handheld device (e.g., a stylus, a pointer, a remote control device, or a gaming accessory), a wearable device (e.g., an earbud, headphones, an electronic watch, a headset, or glasses), or a computing device (e.g., a tablet computer, a smartphone, or a laptop computer).

The device 100 may include a force sensor 102, a haptic engine 104, and optional control circuitry 106. The device 100 may also include other components that are needed for the device 100 to perform the functions for which it is intended (e.g., a display; communications circuitry, such as a Wi-Fi or Bluetooth® interface; or a sensor system).

The force sensor 102 may have a user input surface 108 on which a user may apply a force 114, or the force sensor 102 may be disposed under a user input surface 108 on which a user may apply a force 114. Alternatively, the force sensor 102 may be positioned between a pair of user input surfaces 108, 110, or the device 100 may have a housing 112 that surrounds the force sensor 102. In these latter embodiments, a user may apply a squeeze force 114/116 that may be measured by the force sensor 102.

The user input surface(s) 108, 110 and/or housing 112 may be formed of various materials, including semi-rigid materials (e.g., a hard plastic, metal, or glass) or deformable materials (e.g., a soft plastic, foam, or rubber).

The force sensor 102 may be associated with a configurable user input force threshold. Upon selection of a user input force threshold, a force-based user input may not be recognized by the force sensor 102 until an amount of force applied to the user input surface(s) 108, 110 satisfies (e.g., is greater than) the user input force threshold.

The haptic engine 104 may provide haptic outputs (e.g., haptic feedback) to a user of the device 100. In some cases, the haptic engine 104 may provide a haptic output to acknowledge the receipt of a force-based user input (e.g., an amount of force applied to the user input surface(s) 108, 110, which amount of force satisfies a selected user input force threshold).

The optional control circuitry 106 may be used to control the force sensor 102, haptic engine 104, and/or other components of the device 100. In some embodiments, the control circuitry 106 may include a processor. In some embodiments, the control circuitry 106 may manage the force sensor 102 in accord with a default or selected user input force threshold and/or manage the haptic engine 104 to provide haptic outputs that are associated with the default or selected user input force threshold.

The user input force threshold may in some cases be selected, by a user, from on-board the device 100. Parameters of one or more haptic outputs associated with the selected user input force threshold may be stored on the device 100 or received from another device. In other cases, a selected user input force threshold may be selected by a user of another device and transmitted to the device 100. Parameters of the one or more haptic outputs associated with the selected user input force threshold may be stored on the device 100 or received from the other device (or from a third device).

FIG. 1B shows a system 120 of electronic devices 100, 122 that includes a user input device 100. In some embodiments, the user input device 100 may be the electronic device described with reference to FIG. 1A.

In the system 120, the user input device 100 may be an accessory for the electronic device 122. For example, the device 100 may be a stylus and the device 122 may be a tablet computer or smartphone. Alternatively, the device 100 may be an earbud and the device 122 may be tablet computer, smartphone, or electronic watch. Alternatively, the device 100 may be a gaming accessory (e.g., a gaming controller, a gaming prop, or a glove) and the device 122 may be a gaming console.

In some embodiments, moving the device 100 toward or away from the device 122, or bringing the device 100 proximate to or in contact with the device 122, may change the behavior of the device 100 or device 122. For example, if the device 100 is a stylus and the device 122 is a tablet computer, moving the device 100 toward the device 122 may result in an automatic adjustment, or adaptation, of a user input force threshold associated with the force sensor 102. Moving the device 100 proximate to or in contact with the device 122 (e.g., interacting with the device 122) may disable operation of the force sensor 102 or cause its output to be ignored.

In some embodiments, the user input force threshold associated with the force sensor 102 may be selected on-board the device 100. Alternatively, the user input force threshold may be selected on-board the device 122 (e.g., via a graphical user interface (GUI) displayed on a display 124 of the device 122) and transmitted to the device 100.

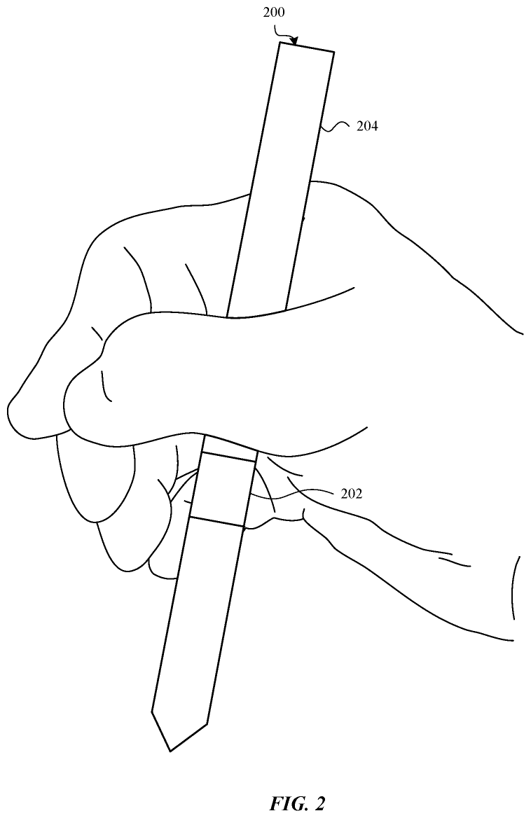

FIG. 2 shows an example of a stylus 200 that includes, or functions as, a user input device. The stylus 200 may include a force sensor and haptic engine that respectively receive a force and provide a haptic output within a squeezable region 202 of a housing 204 of the stylus 200.

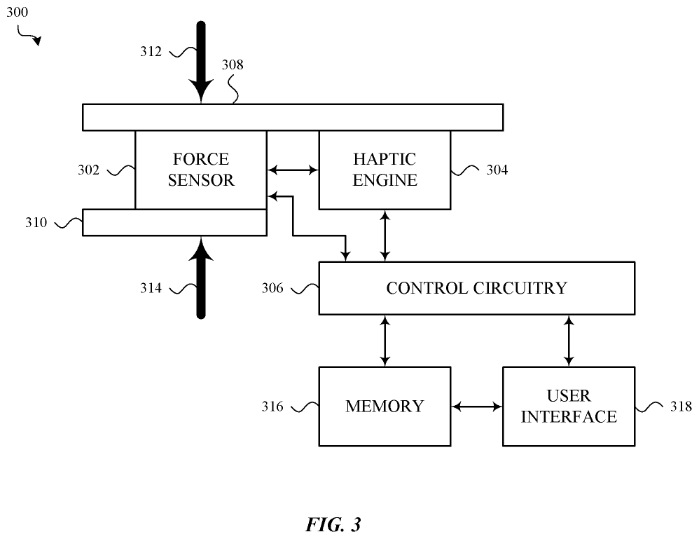

FIG. 3 shows an example of a user input device 300 including a force sensor 302, a haptic engine 304, and optional control circuitry 306. The user input device 300 may be, or may be incorporated into, any of the devices described with reference to FIG. 1A, 1B, or 2.

The force sensor 302 may be operable to determine an amount of force applied to at least one user input surface 308 (or 308 and 310) by a user of the user input device 300. In some embodiments, the force sensor 302 may include a resistive-type force sensor, such as a strain gauge that changes resistance as at least one user input surface 308 or 310 bends in response to the applied force 312 (or 312 and 314). In some embodiments, the force sensor 302 may include a capacitive-type force sensor, such as a mutual capacitance force sensor that changes capacitance as two electrodes (or conductive plates) of the capacitive-type force sensor move closer to one another in response to the applied force 312 (or 312 and 314). The force sensor 302 may alternatively or additionally take other forms.

For some embodiments of the user input device 300, the applied force may include a force 312 applied to a single user input surface 308. In these embodiments, a table, user lap, or other surface will likely support the user input device 300 (or a larger device that includes the user input device 300) and provide some resistance to the force 312 as the force 312 is applied to the user input surface 308.

For some embodiments of the user input device 300, the force sensor 302 may be a squeeze force sensor and the applied force may be a squeeze force. The squeeze force may include a first squeeze force component 312 applied to a first user input surface 308 and a second squeeze force component 314 applied to a second user input surface 310. For example, a squeeze force may be applied to the stylus described with reference to FIG. 2, or to a shaft of an earbud, or to opposite surfaces of a slab type device (e.g., to the front and rear covers, or opposite sides, of a slab-type device such as a mobile phone or tablet computer). In these embodiments, the first and second user input surfaces 308, 310 may in some cases be different portions of the same user input surface (e.g., opposite sides of a stylus housing or earbud having a cylindrical or oval cross-section).

The at least one user input surface 308 (or 308 and 310) may be semi-rigid or deformable (or there may be one of each). The at least one user input surface 308 (or 308 and 310) may be defined by a device housing, by a button, by a material or materials that cover or encapsulate the force sensor 302, or by other means.

The haptic engine 304 may be configured to provide a haptic output to the user of the user input device 300. In some cases, a haptic output may be provided at least partly in response to the amount of force applied to the force sensor 302 satisfying a current configuration of a configurable user input force threshold. For example, the force sensor 302 may be associated with a user input force threshold, and the force sensor 302 may not generate a signal indicating that a user input has been received, or a signal of the force sensor 302 indicating an amount of force applied to the force sensor 302 may not be interpreted as including a receipt of user input, unless the applied force 312 (or 312 and 314) exceeds the user input force threshold.

In some embodiments, the user input force threshold may be configurable. Initially, the user input force threshold may be set to a default user input force threshold. However, a user of the user input device 300 may find the default user input force threshold to be too sensitive or not sensitive enough. The user may therefore select their own user input force threshold (i.e., the user may configure the user input force threshold). Alternatively, someone else may configure the user input force threshold for a user, or an application or other process may configure the user input force threshold based on a determination that one or more conditions have been satisfied. For example, a configurable user input force threshold may be adapted based on an active application, a function being performed using the user input device 300, the environment in which the user input device 300 is being used, or a context in which the user input device 300 is being used.

In some cases, a haptic output may also be provided based at least partly on a predetermined parameter (or parameters). The predetermined parameter(s) may be associated with the current configuration of the configurable user input force threshold. For example, each configuration of the configurable user input force threshold, including the current configuration, may be associated with a set of one or more parameters (e.g., type of haptic output, haptic output waveform, amplitude of haptic output, duration of haptic output, and so on) that are particular to the configuration. In this manner, the haptic engine 304 may provide a similarly feeling haptic output, to a user, regardless of the amount of force applied to the at least one user input surface 308 (or 308 and 310). For example, when a user programs the force sensor 302 to have a relatively lower user input force threshold, the haptic engine 304 may provide the user a relatively less intense haptic feedback (e.g., because the user's relatively lower amount of applied force will provide relatively less dampening to the at least one user input surface 308 (or 308 and 310) and the at least one user input surface 308 (or 308 and 310) will be easier for the haptic engine 304 to move). However, when a user programs the force sensor 302 to have a relatively higher user input force threshold, the haptic engine 304 may provide the user a relatively more intense haptic feedback (e.g., because the user's relatively higher amount of applied force will provide relatively more dampening to the at least one user input surface 308 (or 308 and 310) and the at least one user input surface 308 (or 308 and 310) will be more difficult for the haptic engine 304 to move).

In some embodiments, the user input device 300 may further include a memory 316. The memory 316 may store a set of user input force indications and a set of parameters of haptic outputs. Each parameter of a haptic output in the set of parameters of haptic outputs may be associated with a respective user input force indication in the set of user input force indications.

The control circuitry 306 may include a processor, an integrated circuit (IC), one or more digital circuits, one or more analog circuits, and so on. In some embodiments, the control circuitry 306 may be discrete from the force sensor 302 and haptic engine 304. In some embodiments, the control circuitry 306 may be distributed across two or more devices or functional blocks. In some embodiments, part or all of the control circuitry 306 may be integrated with the force sensor 302 and/or the haptic engine 304.

In some embodiments, the control circuitry 306 may be configured to select a user input force indication, from among the set of user input force indications stored in the memory 316, using a determined amount of force received from the force sensor 302. The determined amount of force may be received, for example, as an analog signal value or a digital signal value. The determined amount of force may be used as a first index into a set of user input force indications. The control circuitry 306 may also retrieve at least one parameter of a haptic output, from among the set of parameters of haptic outputs, using the selected user input force indication as a second index. The control circuitry 306 may then provide the haptic output based at least in part on the retrieved at least one parameter (e.g., by providing the parameter(s), or a haptic output waveform based on the parameter(s), to the haptic engine 304).

In some embodiments, the control circuitry 306 may be configured to select a user input force indication, from among the set of user input force indications stored in the memory 316, using the current configuration of the configurable user input force threshold as a first index into a set of user input force indications. In these embodiments, the force sensor 302 need not indicate a determined amount of force, but may instead just indicate that an applied force satisfies the current configuration of the configurable user input force threshold. The control circuitry 306 may also retrieve at least one parameter of a haptic output, from among the set of parameters of haptic outputs, using the selected user input force indication as a second index. The control circuitry 306 may then provide the haptic output based at least in part on the retrieved at least one parameter (e.g., by providing the parameter(s), or a haptic output waveform based on the parameter(s), to the haptic engine 304).

In some embodiments, the user input force indications may be ranges of applied forces, and the first index may be a force value that is compared to the ranges to determine which range includes the first index. In some embodiments, the user input force indications may be values of user settings (e.g., user input force threshold 1, 2, 3, 4, or 5), and the first index may be a value of one of the user settings, such as a value indicating the current configuration of the configurable user input force threshold. In some embodiments, the user input force indications may be values of user settings; the first index may be a force value; and the first index may need to be mapped to range of applied forces, and then mapped from a particular range of applied forces to a value of a user setting.

In some embodiments, the user input device 300 may include, or be associated with, a user interface 318. The user interface 318 may include, for example, an electronic display and a GUI. The user interface 318 may alternatively or additionally include a voice recognition system, a text entry system, an application programming interface (API), or another type of user interface. The user interface 318 may be used to receive, select, and/or configure a user input force threshold of the force sensor 302.

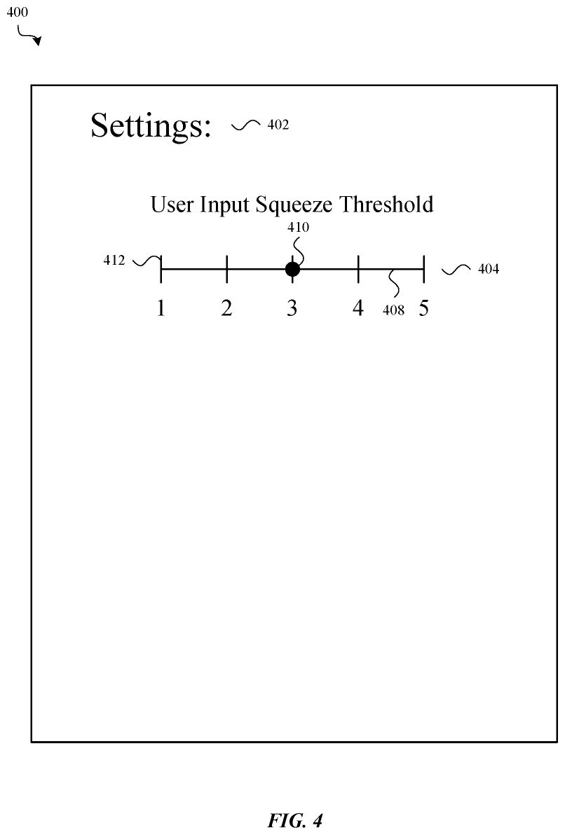

FIG. 4 shows an example GUI 400 that may be displayed on an electronic device, such as one of the electronic devices described with reference to FIG. 1A or 1B. The GUI 400 may be part of a settings menu 402, and may include one or more of a widget 404 (e.g., a slider), an icon, a text input field, or other means that enables a user to select (or configure) a configurable user input force threshold for a force sensor.

By way of example, the GUI 400 includes a widget 404 in the form of a slider. The slider may include a track 408 and a thumb 410, with the thumb 410 being selectable and slidable along the track 408 by means of a finger, stylus, or mouse. By way of further example, the track 408 is associated with five ticks 412, and the thumb 410 may snap to the ticks 412. In this manner, the configurable user input force threshold may be set to one of five different settings. In other embodiments, there may be more (e.g., ten), fewer (e.g., three), or continuously variable settings.

In some cases, a user input force threshold may also or alternatively be selected as part of an on-boarding process, in which a user applies a desired amount of force to at least one user input surface; the applied force is measured; and the measured force is used to select a corresponding user input force threshold.

FIG. 5 shows an example mapping 500 of different user input force thresholds 502 to different parameters 504, 506 of a haptic output.

By way of example, five user input force thresholds 502 are mapped to parameters 504, 506 in the mapping 500. The five user input force thresholds 502 are numbered 1 through 5. Other mappings may include more or fewer user input force thresholds 502. Although each of the user input force thresholds 502 is identified by a respective number (e.g., 1 through 5), each user input force threshold may correspond to a different amount of force applied to a force sensor, and each user input force threshold may be satisfied by a range of applied forces that are between “equal to or greater than the user input force threshold” and “less than a next greater user input force threshold”.

Each user input force threshold may be mapped to a set of one or more parameters 504, 506. For example, user input force threshold 1 is mapped to parameters 1a, 1b, and so on, and user input force threshold 2 is mapped to parameters 2a, 2b, and so on.

By way of example, the parameters 504 may indicate a type of haptic output (e.g., micro tap, mini tap, et cetera; or type of haptic output waveform) that is associated with a particular user input force threshold. The parameters 506 may indicate an amplitude (or gain, or intensity) at which the type of haptic output indicated by one of the parameters 504 is played by a haptic engine. In some embodiments, there may be more or fewer parameters 504, 506 associated with one of the user input force thresholds 502.

Because the amount of force applied to a user input surface (or surfaces) is associated with an application of force and a release of force, a first haptic output may be provided to a user at least partly in response to the application of force satisfying a first user input force threshold (e.g., a current configuration of a user input force threshold), and a second haptic output may be provided to the user at least partly in response to the release of force no longer satisfying a second user input force threshold (e.g., the current configuration of the user input force threshold, or a predetermined or configured lower user input force threshold). In these embodiments, some of the parameters in the mapping 500 (e.g., the parameters 504 and 506) may be parameters that define a first haptic output upon the application of force, and other parameters may be parameters that define a second haptic output upon the release of force. In alternative embodiments, the same parameter(s) may be used to define both the first haptic output and the second haptic output. In other alternative embodiments, the user input force thresholds 502 may be application of force thresholds, and the user input force thresholds 502 may be mapped to corresponding release of force thresholds. The release of force thresholds may differ from the application of force thresholds, thereby providing some hysteresis between determining that a force (or an amount of force) has been applied and providing the first haptic output, and determining that the force (or the amount of force) has been released and providing the second haptic output.

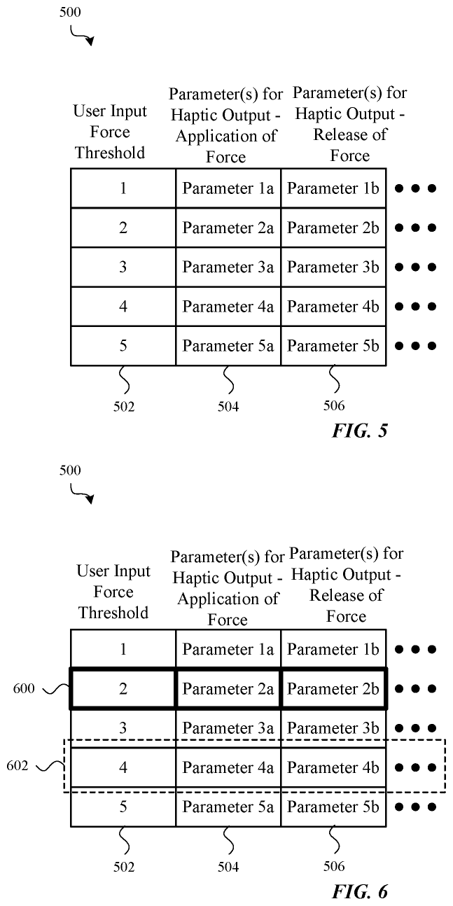

Despite a user being able to configure a user input force threshold for a user input device, the amount of force that a user applies when providing a user input may vary. For example, consider a stylus. When the user is grasping the stylus in the air, the user may provide a first amount of force with an intent to trigger a user input. When the user is grasping the stylus while their arm or hand is resting on a table or other surface, the user may provide a second amount of force (e.g., a greater amount of force) with an intent to trigger a user input. When the user is using the stylus to write or draw on another device (e.g., to provide input to a tablet computer), or when the user is using the stylus to write or draw on a table or other surface (e.g., to provide input recorded by the user input device), the user may apply varying amounts of force to the user input device with no intent to trigger a user input other than the strokes contained in their writing or drawing. As a result, it may be desirable to determine whether a set of one or more conditions is satisfied and adjust (or adapt) a default or configured user input force threshold. In this regard, FIG. 6 illustrates an example adjustment of a user input force threshold.

FIG. 6 shows the same mapping 500 shown in FIG. 5 (i.e., a mapping 500 of different user input force thresholds 502 to different parameters 504, 506 of a haptic output). FIG. 6 also calls out one line 600 of the mapping 500. The line 600 corresponds to a current configuration of a user input force threshold, and to the parameters 504, 506 of a haptic output associated with the current configuration.

Line 602 of the mapping 500 correspond to a second configuration of the user input force threshold. The second configuration may be associated with a second user input force threshold that is greater than the current configuration of the user input force threshold. In some embodiments, the second user input force threshold may be a predetermined amount greater than the current configuration of the user input force threshold. Alternatively, the second user input force threshold may be associated with a user input force threshold setting (e.g., 4) that is a predetermined number of one or more settings above (e.g., 2 settings above) the setting associated with the current configuration of the user input force threshold (e.g., 2). Alternatively, the second user input force threshold may be dynamically determined based on the current configuration of the user input force threshold and/or a determination that a set of one or more conditions are satisfied.

In operation, a haptic engine operated in accord with the mapping 500 shown in FIG. 6 may be configured to provide a haptic output to the user. The haptic output may be provided at least partly in response to the amount of force applied to a user input device satisfying a first user input force threshold (e.g., the current configuration of the user input force threshold, shown in line 600 of the mapping 500) when a set of one or more conditions is not satisfied. However, the haptic output may be provided at least partly in response to the amount of force satisfying a second user input force threshold (e.g., the user input force threshold shown in line 602 of the mapping 500) while the set of one or more conditions is satisfied, or within a time period after the set of one or more conditions is satisfied.

The set of one or more conditions for which a user input force threshold is adapted may take various forms. Some examples have already been provided. As another example, the set of one or more conditions may include a movement of a stylus housing (in which a user input device is housed) that suggests an intention of the stylus user to write, draw, or interact with another device using the stylus. The set of one or more conditions may alternatively or additionally include moving the stylus housing proximate a cover over a display of a tablet computer, or toward a cover over another a display of another type of electronic device. A user input force threshold may be increased when such condition(s) are satisfied because a user tends to increase their baseline grip of a stylus more firmly when they are moving into position to write, draw, or interact with another device, and increasing the user input force threshold can prevent accidental triggers of user input. In some embodiments, a user input force threshold may be increased to a maximum setting, or the recognition of force-based user input may be disabled or ignored (and no input may be registered), while a user is in the act of writing, drawings, or interacting with another device using a stylus (e.g., while the stylus is in contact with another electronic device or a writing/drawing surface).

In an environment or context in which consecutive force-based user inputs are unexpected, a user input force threshold may be increased for a period of time (e.g., two seconds) following the receipt of a force-based user input.

Any increase or decrease of a user input force threshold may be temporary, or contextual, and a default or selected user input force threshold may be restored after a period of time.

The set of one or more conditions that need to be satisfied before adjustment of a user input force threshold may be monitored, for example, using one or more of an accelerometer or gyroscope housed with a user input device, and/or by a proximity sensor housed with the user input device or housed in a device that the user input device may approach, or by other means. Determinations regarding the satisfaction of various conditions may be made on-board a first electronic device including a user input device; remotely, by a second electronic device that is capable of detecting or determining aspects of the first electronic device, or capable of receiving data from the first electronic device; or by a combination of the first electronic device, the second electronic device, and/or one or more other electronic devices.

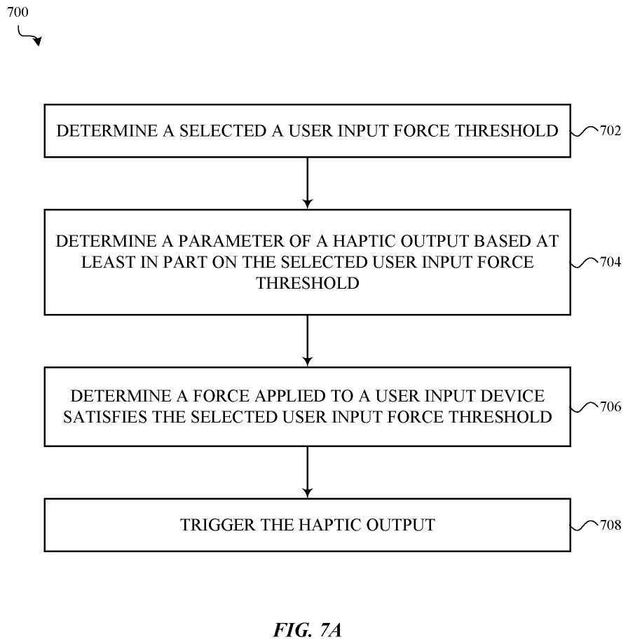

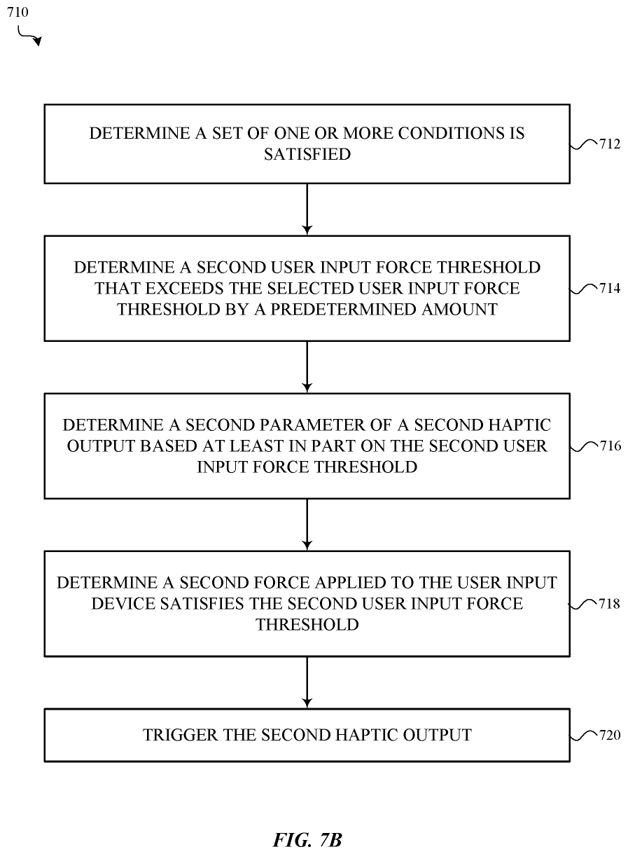

FIG. 7A shows an example method 700 of operating a user input device. Operation of the user input device in accord with the method 700 may include, for example, configuring a user input force threshold and triggering a haptic output.

At 702, the method 700 may include determining a selected user input force threshold. The selected user input force threshold may be a default user input force threshold or a user-configured, system-configured, or application-configured user input force threshold. However, the user input force threshold is “selected” in that it is selected from among more than one possible user input force threshold.

At 704, the method 700 may include determining a parameter or parameters of a haptic output. The parameter(s) may be determined based at least in part on the selected user input force threshold. In some embodiments, the determined parameter(s) may be associated with the selected user input force threshold. In some embodiments, the determined parameter(s) may not be associated with the selected user input force threshold (e.g., when a selected user input force threshold is adjusted based on a set of one or more conditions being satisfied). The parameter(s) of the haptic output may be retrieved from a stored set of parameters associated with respective possible selections of the user input force threshold.

At 706, the method 700 may include determining that an amount of force applied to at least one user input surface of the user input device satisfies the selected user input force threshold.

At 708, the method 700 may include triggering, at least partly in response to the amount of force applied to the at least one user input surface satisfying the selected user input force threshold, the haptic output. The haptic output may be based at least in part on the parameter(s) of the haptic output.

In accord with the method 700, different user input force thresholds may be associated with their own respective haptic output parameter(s), such that the application of different amounts of force to the at least one user input surface trigger different haptic outputs being triggered. In this manner, and in some embodiments, a user may be provided a haptic output that is perceived by users to feel the same, regardless of what user input force threshold is selected, and regardless of how much an applied amount of force tends to dampen a haptic output provided to the at least one user input surface. In some cases (e.g., gaming purposes), haptic outputs having their own (and possibly different) parameters may be provided in response to different amounts of applied force for other reasons.

FIG. 7B shows another example method 710 of operating a user input device.

Operation of the user input device in accord with the method 710 may include, for example, adjusting a user input force threshold. The adjustment may occur in response to a set of one or more conditions being satisfied.

At 712, the method 710 may include determining a set of one or more conditions is satisfied. The conditions may be any of the conditions described herein, including those described with reference to FIGS. 5 and 6.

At 714, the method 710 may include determining a second user input force threshold that exceeds a selected (or first) user input force threshold by a predetermined amount.

At 716, the method 710 may include determining a second parameter or parameters of a second haptic output. The second parameter(s) may be determined based at least in part on the second user input force threshold. The second parameter(s) of the haptic output may be retrieved from a stored set of parameters associated with respective possible selections of the user input force threshold.

At 718, the method 710 may include determining, at least one of while the set of one or more conditions is satisfied or within a time period after the set of one or more conditions is satisfied, that a second amount of force applied to the user input device satisfies the second user input force threshold.

At 720, the method 710 may include triggering, at least partly in response to the determination the second amount of force applied to the user input device satisfies the second user input force threshold, the second haptic output. The second haptic output may be based at least in part on the second parameter(s) of the second haptic output.

The methods 700 and 710 may be variously embodied, extended, or adapted, as described in the above paragraphs and elsewhere in this description. The methods 700, 710 may also be combined.

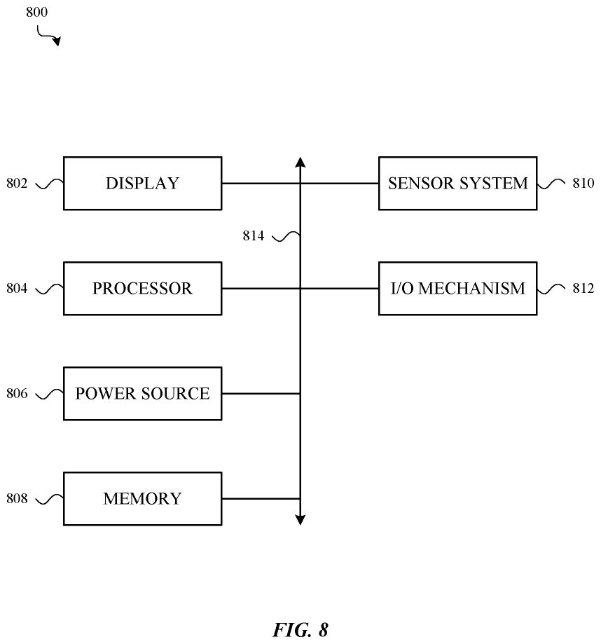

FIG. 8 shows an example electrical block diagram of an electronic device, such as one of the electronic devices described with reference to FIG. 1A, 1B, or 2. The electronic device 800 may take any of the forms described herein, or other forms. The electronic device 800 may include an optional display 802 (e.g., a light-emitting display), a processor 804 (or other control circuitry), a power source 806, a memory 808 or storage device, a sensor system 810, and an optional input/output (I/O) mechanism 812 (e.g., an input/output device and/or input/output port). The processor 804 may control some or all of the operations of the electronic device 800. The processor 804 may communicate, either directly or indirectly, with substantially all of the components of the electronic device 800. For example, a system bus or other communication mechanism 814 may provide communication between the processor 804, the power source 806, the memory 808, the sensor system 810, and/or the input/output mechanism 812.

The processor 804 may be implemented as any electronic device capable of processing, receiving, or transmitting data or instructions. For example, the processor 804 may be a microprocessor, a central processing unit (CPU), an ASIC, or a DSP, or may include any combination of such devices and/or other control circuitry (including digital and/or analog control circuitry). As described herein, the term “processor” is meant to encompass a single processor or processing unit, multiple processors, multiple processing units, or another suitably configured computing element or elements.

In some embodiments, the components of the electronic device 800 may be controlled by multiple processors. For example, select components of the electronic device 800 may be controlled by a first processor and other components of the electronic device 800 may be controlled by a second processor, where the first and second processors may or may not be in communication with each other.

The power source 806 may be implemented with any device capable of providing energy to the electronic device 800. For example, the power source 806 may include one or more disposable or rechargeable batteries. Additionally or alternatively, the power source 806 may include a power connector or power cord that connects the electronic device 800 to another power source, such as a wall outlet, or a wireless charging interface.

The memory 808 may store electronic data that may be used by the electronic device 800. For example, the memory 808 may store electrical data or content such as, for example, user input force threshold settings, parameters of haptic outputs associated with the user input force thresholds, audio and video files, documents and applications, device settings and user preferences, timing signals, control signals, data structures or databases, image data, maps, or focus settings. The memory 808 may be configured as any type of memory. By way of example only, the memory 808 may be implemented as random access memory, read-only memory, Flash memory, removable memory, other types of storage elements, or combinations of such devices.

The electronic device 800 may also include one or more sensors defining the sensor system 810. The sensors may be positioned substantially anywhere on the electronic device 800. The sensor(s) may be configured to sense substantially any type of characteristic, such as but not limited to, touch, force, pressure, electromagnetic radiation (e.g., light), heat, movement, relative motion, biometric data, distance, and so on. For example, the sensor system 810 may include a touch sensor, a force sensor, a heat sensor, a position sensor, a light or optical sensor, an accelerometer, a pressure sensor (e.g., a pressure transducer), a gyroscope, a magnetometer, a health monitoring sensor, an image sensor, a proximity sensor, and so on. Additionally, the one or more sensors may utilize any suitable sensing technology, including, but not limited to, capacitive, ultrasonic, resistive, optical, ultrasound, piezoelectric, and thermal sensing technologies.

The I/O mechanism 812 may transmit and/or receive data from a user or another electronic device. An I/O device may include a display, a touch sensing input surface such as a track pad, one or more buttons (e.g., a graphical user interface “home” button, or one of the buttons described herein), one or more cameras (including one or more 2D or 3D image sensors (e.g., one or more SPAD-based photon detectors)), one or more microphones or speakers, one or more ports such as a microphone port, and/or a keyboard. Additionally or alternatively, an I/O device or port may transmit electronic signals via a communications network, such as a wireless and/or wired network connection. Examples of wireless and wired network connections include, but are not limited to, cellular, Wi-Fi, Bluetooth®, infrared (IR), and Ethernet connections. The I/O mechanism 812 may also provide feedback (e.g., a haptic output) to a user.

The foregoing description, for purposes of explanation, uses specific nomenclature to provide a thorough understanding of the described embodiments. However, it will be apparent to one skilled in the art, after reading this description, that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art, after reading this description, that many modifications and variations are possible in view of the above teachings.

What is claimed is:

1. A user input device, comprising:
a force sensor operable to determine an amount of force applied to at least one user input surface; and
a haptic engine configured to provide a haptic output, the haptic output provided at least partly in response to the amount of force satisfying a current configuration of a configurable user input force threshold and based at least partly on a predetermined parameter associated with the current configuration of the configurable user input force threshold.

2. The user input device of claim 1, further comprising:
a memory storing a set of user input force indications and a set of parameters of haptic outputs, each parameter of a haptic output in the set of parameters of haptic outputs associated with a respective user input force indication in the set of user input force indications; and
control circuitry configured to,
select a user input force indication, from among the set of user input force indications, using a determined amount of force received from the force sensor as a first index;
retrieve at least one parameter of a haptic output, from among the set of parameters of haptic outputs, using the selected user input force indication as a second index; and
provide the haptic output based at least in part on the retrieved at least one parameter.

3. The user input device of claim 1, further comprising:
a memory storing a set of user input force indications and a set of parameters of haptic outputs, each parameter of a haptic output in the set of parameters of haptic outputs associated with a respective user input force indication in the set of user input force indications; and
control circuitry configured to,
select a user input force indication, from among the set of user input force indications, using the current configuration of the configurable user input force threshold as a first index;
retrieve at least one parameter of a haptic output, from among the set of parameters of haptic outputs, using the selected user input force indication as a second index; and
provide the haptic output based at least in part on the retrieved at least one parameter.

4. The user input device of claim 1, wherein:
the amount of force applied to the at least one user input surface is associated with an application of force and a release of force; and
the haptic output is a first haptic output provided at least partly in response to the application of force satisfying the current configuration of the configurable user input force threshold.

5. The user input device of claim 4, wherein the haptic engine is configured to provide a second haptic output, the second haptic output provided at least partly in response to the release of force no longer satisfying a second user input force threshold and based at least partly on a second predetermined parameter associated with the second user input force threshold.

6. The user input device of claim 5, wherein the second user input force threshold is equal to the current configuration of the configurable user input force threshold.

7. The user input device of claim 1, further comprising a device housing, the device housing defining the at least one user input surface.

8. The user input device of claim 7, wherein the device housing is a stylus housing.

9. The user input device of claim 1, wherein the force sensor is a squeeze force sensor.

10. The user input device of claim 1, wherein the force sensor comprises a strain gauge.

11. A user input device, comprising:
a force sensor operable to determine an amount of force applied to at least one user input surface;
control circuitry configured to determine whether a set of one or more conditions is satisfied; and
a haptic engine configured to provide a haptic output, the haptic output provided at least partly in response to the amount of force satisfying a first user input force threshold when the set of one or more conditions is not satisfied, the haptic output provided at least partly in response to the amount of force satisfying a second user input force threshold while the set of one or more conditions is satisfied or within a time period after the set of one or more conditions is satisfied, and the second user input force threshold greater than the first user input force threshold.

12. The user input device of claim 11, further comprising:
a stylus housing defining the at least one user input surface; wherein,
the set of one or more conditions includes a movement of the stylus housing, the movement suggesting an intention of a user to,
write using the user input device; or
draw using the user input device.

13. The user input device of claim 11, further wherein the set of one or more conditions includes an interaction of the user input device with another device.

14. The user input device of claim 11, further comprising:
a stylus housing defining the at least one user input surface; wherein,
the set of one or more conditions includes a positioning of the stylus housing proximate a cover over a display of a tablet computer.

15. The user input device of claim 11, wherein the first user input force threshold is a current configuration of a configurable user input force threshold.

16. The user input device of claim 11, wherein the force sensor is a squeeze force sensor.

17. A method of operating a user input device, comprising:
determining a selected user input force threshold;
determining a parameter of a haptic output based at least in part on the selected user input force threshold;
determining that an amount of force applied to at least one user input surface of the user input device satisfies the selected user input force threshold; and
triggering, at least partly in response to the amount of force applied to the at least one user input surface satisfying the selected user input force threshold, the haptic output, the haptic output based at least in part on the parameter of the haptic output.

18. The method of claim 17, wherein the determined parameter of the haptic output is associated with the selected user input force threshold.

19. The method of claim 17, further comprising:
determining a set of one or more conditions is satisfied;
determining a second user input force threshold that exceeds the selected user input force threshold by a predetermined amount;
determining a second parameter of a second haptic output based at least in part on the second user input force threshold;
determining, at least one of while the set of one or more conditions is satisfied or within a time period after the set of one or more conditions is satisfied, that a second amount of force applied to the user input device satisfies the second user input force threshold; and
triggering, at least partly in response to the determination the second amount of force applied to the user input device satisfies the second user input force threshold, the second haptic output, the second haptic output based at least in part on the second parameter of the second haptic output.

20. The method of claim 17, wherein the parameter of the haptic output is retrieved from a stored set of parameters associated with respective possible selections of the user input force threshold.
